(19) United States
(12) Patent Application Publication
(10) Pub. No.: US 2022/0244194 A1
(43) Pub. Date: Aug. 4, 2022

(54) AUTOMATED INSPECTION METHOD FOR A MANUFACTURED ARTICLE AND SYSTEM FOR PERFORMING SAME

(71) Applicant: Lynx Inspection Inc., Quebec (CA)

(72) Inventors: Luc Perron, Quebec (CA); Roger Booto Tokime, Quebec (CA)

(73) Assignee: Lynx Inspection Inc., Quebec, QC (CA)

(21) Appl. No.: 17/596,200

(22) PCT Filed: Jun. 4, 2020
(86) PCT No.: PCT/CA2020/050772

§ 371 Date: Dec. 4, 2021

Related U.S. Application Data
(60) Provisional application No. 62/857,462, filed on Jun. 5, 2019.

(51) Int. Cl. G01N 21/95

(52) U.S. Cl. CPC G01N 21/95; G01N 2021/8887

(57) ABSTRACT

A method and system for performing inspection of a manufactured article includes acquiring a sequence of images using an image acquisition device of the article under inspection. The sequence of images is acquired while relative movement between the article and the image acquisition device is caused. At least one feature characterizing the manufactured article is extracted from the acquired sequence of images. The acquired sequence of images is classified based in part on the extracted feature. The classification may include determining an indication, of a presence of a manufacturing defect in the article, and may include identifying a type of manufacturing defect. The extracting and the classifying can be performed by a computer-implemented classification module, which may be trained by machine learning techniques.

### RELATED PATENT APPLICATION

The present application claims priority from U.S. provisional application No. 62/857,462 filed Jun. 5, 2019 and entitled “AUTOMATED INSPECTION METHOD FOR A MANUFACTURED ARTICLE AND SYSTEM FOR PERFORMING SAME”, the disclosure of which is hereby incorporated by reference in its entirety.

### TECHNICAL FIELD

The present disclosure generally relates to the field of industrial inspection. More particularly, it relates to a method for performing industrial inspection and/or non-destructive test (NDT) of a manufactured article and to a system for performing the industrial inspection and/or NDT of a manufactured article in which at least one feature characterizing the manufactured article is extracted from a sequence of images acquired of the article.

### BACKGROUND

Numerous inspection methods and systems are known in the art for performing industrial inspection and/or Non-Destructive Testing (NDT) of manufactured articles. In many cases, machine vision applications can be solved using basic image processing tools that analyze the content of acquired 2D imagery. However, in recent years new applications performing 3D analysis of the data are getting more popular, given their additional inspection capabilities.

With regards to industrial inspection, one of the essential requirements is the ability to measure the dimensions of an article against specifications for this particular article or against a standard thereof, which can be referred to as “Industrial Metrology”. On the other hand, NDT refers to a wider range of applications and also extends to the inspection of the inner portion of the article, for detection of subsurface defects.

Common industrial inspection tools include optical devices (i.e. optical scanners) capable of performing accurate measurements of control points and/or complete 3D surface scan of a manufactured object. Such optical scanners can be hand operated or mounted on a robotic articulated arm to perform fully automated measurements on an assembly line. Such devices however tend to suffer from several drawbacks. For example, the inspection time is often long as a complete scan of a manufactured article can take several minutes to complete, especially if the shape of the article is complex. Moreover, optical devices can only scan the visible surface of an object, thereby preventing the use of such devices for the metrology of features that are inaccessible to the scanner or the detection of subsurface defects. Hence, while such devices can be used for industrial metrology, their use is limited to such a field and cannot be extended to wider NDT applications.

One alternative device for performing industrial metrology is Computed Tomography (CT), where a plurality of X-ray images is taken from different angles and computer-processed to produce cross-sectional tomographic images of a manufactured article. CT however also suffers from several drawbacks. For example, conventional CT methods require a 360° access around the manufactured article which can be achieved by rotating the sensor array around the article or by rotating the object in front of the sensor array. However, rotating the manufactured article limits the size of the article which can be inspected and imposes some restrictions on the positioning of the object, especially for relatively flat objects. Moreover, CT reconstruction is a fairly computer intensive application (which normally requires some specialized processing hardware), requiring fairly long scanning and reconstruction time. For example, a high-resolution CT scan in the context of industrial inspection typically requires more than 30 minutes for completion followed by several more minutes of post processing. Faster CT reconstruction methods do exist, but normally result in lower quality and measurement accuracy, which is undesirable in the field of industrial inspection. Therefore, use of CT is unadapted to high volume production, such as volumes of 100 articles per hour or more. Finally, CT equipment is generally costly, even for the most basic industrial CT equipment.

With regards to general NDT, non-tomographic industrial radiography (e.g. film-based, computed or digital radiography) can be used for inspecting materials in order to detect hidden flaws. These traditional methods however also tend to suffer from several drawbacks. For example, defect detection is highly dependent on the orientation of such defects in relation to the projection angle of the X-ray (or gamma ray) image. Consequently, defects such as delamination and planar cracks, for example, tend to be difficult to detect using conventional radiography. As a result, alternative NDT methods are often preferred to radiography, even if such methods are more time consuming and/or do not necessarily allow assessing the full extent of a defect and/or do not necessarily allow locating the defect with precision.

PCT publication no. WO2018/014138 generally describes a method and system for performing inspection of a manufactured article that includes acquiring a sequence of radiographic images of the article; determining a position of the article for each one of the acquired radiographic images; and performing a three-dimensional model correction loop to generate a match result, which can be further indicative of a mismatch.

### SUMMARY

According to one aspect, there is provided a method for performing inspection of a manufactured article. The method includes acquiring a sequence of images of the article using an image acquisition device, the acquisition of the sequence of images being performed as relative movement occurs between the article and the image acquisition device, extracting, from the acquired sequence of images, at least one feature characterizing the manufactured article, and classifying the acquired sequence of images based in part on the at least one extracted feature.

According to another aspect, there is provided a system for performing inspection of a manufactured article. The system includes an image acquisition device configured to acquire a sequence of images of the manufactured article as relative movement occurs between the article and the image acquisition device and a computer-implemented classification module configured to extract at least one feature characterizing the manufactured article and to classify the acquired sequence of images based in part on the at least one extracted feature.

According to various aspects described herein, the extracting of the least one feature and the classifying the acquired sequence of images can be performed by a computer-implemented classification module. The classification module may be trained based on a training captured dataset of a plurality of previously acquired sequences of images, each sequence representing one sample of the training captured dataset. The classification module may be trained by applying a machine learning algorithm. For example, the classification module may be a convolutional neural network.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates a schematic diagram representing the data flow within a method and system for performing inspection of a manufactured article according to an example embodiment;

FIG. 2 illustrates a schematic diagram of an image acquisition device, a motion device and manufactured articles according to an example embodiment;

FIG. 3 illustrates a schematic diagram of sequence of acquired images captured for a manufacture article according to an example embodiment;

FIG. 4 illustrates a flowchart of the operational steps of a method for inspecting a manufactured article according to example embodiment;

FIG. 5A is a schematic diagram of an encoder-decoder network architecture used in a first experiment;

FIG. 5B shows the convolution blocks of the encoder of the network of the first experiment;

FIG. 5C shows a pooling operation of the network of the first experiment;

FIG. 5D shows the convolution blocks of the decoder of the network of the first experiment;

FIG. 5E shows the prediction results of the encoder-decoder network of the first experiment on a radiographic image;

FIG. 6A shows a schematic diagram of the FCN architecture of a second experiment;

FIG. 6B shows an example an overview of the feature map that activates the layers of the network of the second experiment;

FIG. 6C shows the result of applying the network of the second experiment to test data;

FIG. 6D shows the predictions made by the network of the second experiment to non-weld images;

FIG. 7A illustrates a schematic diagram of a U-Net network of a third experiment;

FIG. 7B shows the input and output data computed by each layer of the U-Net network of the third experiment;

FIG. 7C shows predictions made by the network of the third experiment without sliding window;

FIG. 7D shows predictions made by the network of the third experiment with sliding window; and

FIG. 7E shows the detection made by the network of third experiment on a non-weld image with sliding window.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

In general terms, the methods and systems described herein according to various example embodiments involve capturing a sequence of images of a manufactured article as the article is in movement relative to the image acquisition device. The sequence of images is then processed as a single sample to classify that sequence. The classification of the sequence can provide an indicator useful in inspection of the manufactured article. The methods and systems described herein are applicable to manufactured articles from diverse fields, such as, without being limitative, glass bottle, plastic molded components, die casting parts, additive manufacturing components, wheels, tires and other manufactured of refactored parts for the automotive, military or aerospace industry. The above examples are given as indicators only and one skilled in the art will understand that several other types of manufactured articles can be subjected to inspection using the present method. In an embodiment, the articles are sized and shaped to be conveyed on a motion device for inline inspection thereof. In an alternative embodiment, the article can be a large article, which is difficult to displace, such that components of the inspection system should rather be displaced relative to the article.

The manufactured article to be inspected (or region of interest thereof) can be made of more than one known material with known positioning, geometry and dimensional characteristics of each one of the portions of the different materials. For ease of description, in the course of the description, only reference to inspection of an article will be made, but it will be understood that, in an embodiment, inspection of only a region or volume of interest of the article can be performed. It will also be understood that the method can be applied successively to multiple articles, thereby providing scanning of a plurality of successive articles, such as in a production chain or the like.

While inspection methods and systems described herein can be applied in a production line context in one example embodiment in which the manufactured articles under inspection are the ones produced by the production line, it will be understood that the methods and systems can also be applied outside this context, such as in a construction context. Accordingly, the manufactured articles can include infrastructure elements, such as pipelines, steel structures, concrete structures, or the like, that are to be inspected.

The inspection methods and systems described herein can be applied to inspect the manufactured article for one or more defects found therein. Such defects may include, without being limitative, porosity, pitting, blow hole, shrinkage or any other type of voids in the material, inclusions, dents, fatigue damages and stress corrosion cracks, thermal and chemically induced defects, delamination, misalignments and geometrical anomalies resulting from the manufacturing process or wear and tear. The inspection methods and systems described herein can be useful to automatize the inspection process (ex: for high volume production contexts), thereby reducing costs and/or improving productivity/efficiency.

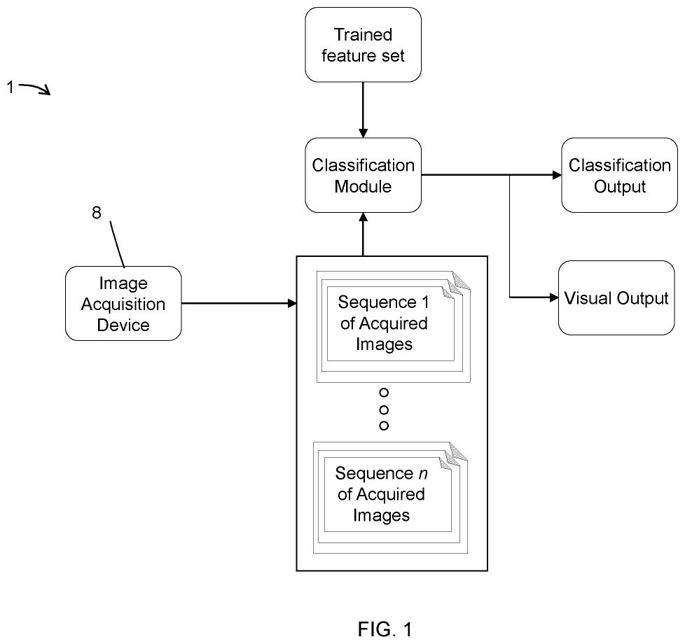

Referring now to FIG. 1, therein illustrated is a schematic diagram representing the data flow 1 within a method and system for performing inspection of a manufactured article. The data flow can also be representative of the operational steps for performing the inspection of the manufactured article. In deployment, the method and system is applied generally to a series of manufactured articles that are intended to be identical (i.e. the same article). The method can be applied to each manufactured article as a whole or to a set of one or more corresponding regions or volumes of interest within each manufactured article. Accordingly, the method and system can be applied successively to multiple articles intended to be identical, thereby providing scanning and inspection of a plurality of successive articles, such as in a production chain environment.

An image acquisition device 8 is operated to capture a sequence of images for each manufactured article. This corresponds to an image acquisition step of the method for inspection of the manufactured article. The sequence of images for the given manufactured article is captured as relative movement occurs between the manufactured article and the image acquisition device 8. Accordingly, each image of the sequence is acquired at a different physical position in relation to the image acquisition device, thereby providing different image information relative to any other image of the sequence. The position of each acquired image can be tracked.

In an example embodiment, the manufactured article is conveyed on a motion device at a constant speed, such that the sequence of image is acquired in a continuous sequence at a known equal interval. The manufactured article can be conveyed linearly with regard to the radiographic image acquisition device. For example, the motion device can be a linear stage, a conveyor belt or other similar device. It will be understood that, the smaller the interval between the images of the sequence of acquired images, the denser the information that is contained in the acquired images, which further allows for increased precision in the inspection of the manufactured article.

The manufactured article can also be conveyed be in a non-linear manner. For example, the manufactured article can be conveyed rotationally or along a curved path relative to the image acquisition device 8. In other applications, the manufactured article can be conveyed on a predefined path that has an arbitrary shape relative to the image acquisition device 8. Importantly, the manufactured article is conveyed along the path such that at every instance when the image acquisition device 8 acquires an images of the manufactured article during the relative movement, the relative position between the manufactured article and the image acquisition device is known for that instance.

In an alternative embodiment, the acquisition of the sequence of images can be performed as the image acquisition device 8 is displaced relative to the article.

The image acquisition device 8 can be one or more of a visible range camera (standard CMOS sensor-based camera), a radiographic image acquisition device, or an infrared camera. In the case of a radiographic image acquisition device, the device may include one or more radiographic sources, such as, X-ray source(s), or gamma-ray source(s), and corresponding detector(s), positioned on opposed sides of the article. Other image acquisition devices may include, without being limitative, computer vision cameras, video cameras, line scanners, electronic microscopes, infrared and multispectral cameras and imaging systems in other bands of the electromagnetic spectrum, such as ultrasound, microwave, millimeter wave, or terahertz. It will be understood that while industrial radiography is a commonly used NDT technique, methods and systems described herein according to various example embodiments is also applicable to images other than radiography images, as exemplified by the different types of image acquisition devices 8 described hereinabove.

The image acquisition device 8 can also include a set of at least two image acquisition devices 8 of the same type or of different types. Accordingly, the acquired sequence of images can be formed by combining the images captured by the images captured by the two or more image acquisition devices 8. It will be further understood that in some example embodiments, the sequence of images can include images captured by two different types of image acquisition devices 8.

In one example embodiment, for each manufactured article, the step of acquiring the sequence of images of the manufactured article can include acquiring at least about 25 images, with each image providing a unique viewing angle of the manufactured article. The step of acquiring successive images of the article can include acquiring at least about one hundred images, with each image providing a unique viewing angle of the article.

The step of acquiring images can include determining a precise position of the manufactured article for each one of the acquired images. This determining includes determining a precise position and orientation of the article relative to the radiographic source(s) and corresponding detector(s) for each one of the acquired images. In other words, the article can be registered in 3D space, which may be useful for generating simulated images for a detailed 3D model. In an embodiment where the article is linearly moved by the motion device, the registration must be synchronized with the linear motion device so that a sequence of simulated images that matches the actual sequence of images can be generated.

In an embodiment, the precise relative position (X, Y and Z) and orientation of the article with regards to the image acquisition device 8 is determined through analysis of the corresponding acquired images, using intensity-based or feature-based image registration techniques, with or without fiducial points. In an embodiment, for greater precision, an acquired surface profile of the article can also be analysed and used, alone or in combination to the corresponding acquired images, in order to determine the precise position of the article. In such an embodiment, the positioning of the image acquisition device 8 relative to a device used for acquiring the surface profile is known and used to determine the position of the article relative to the image acquisition device.

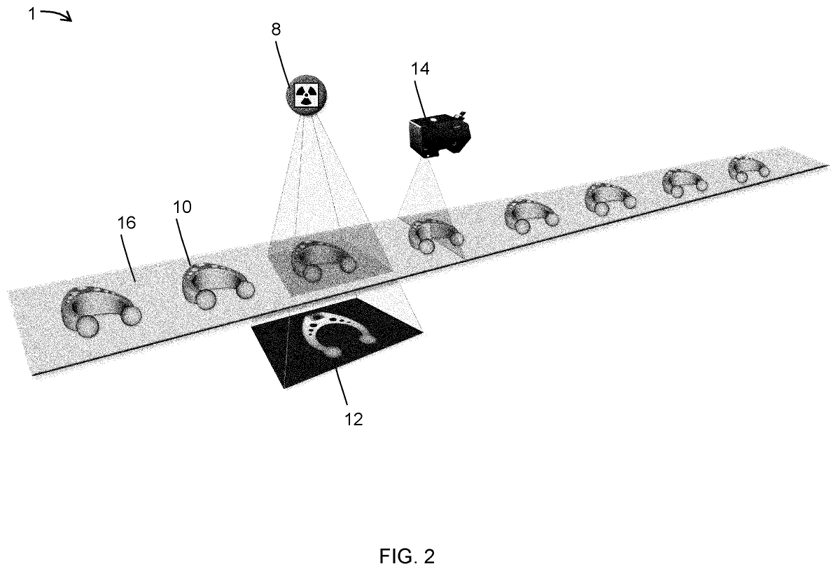

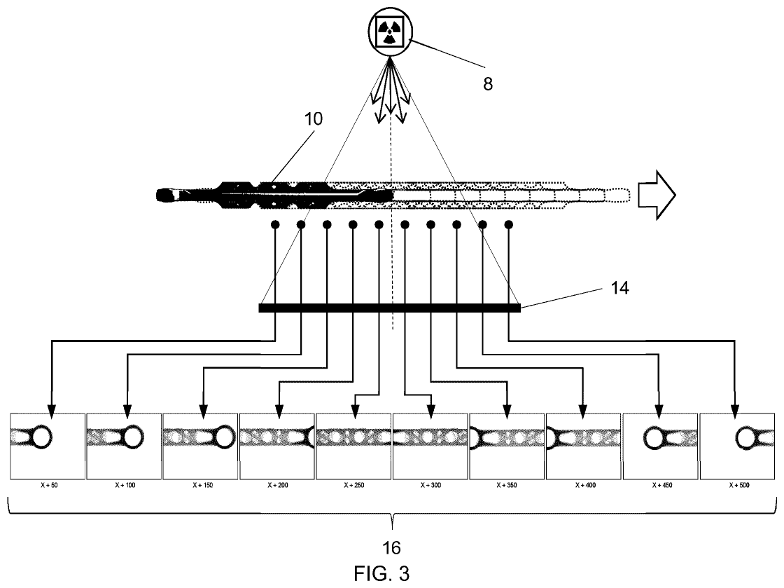

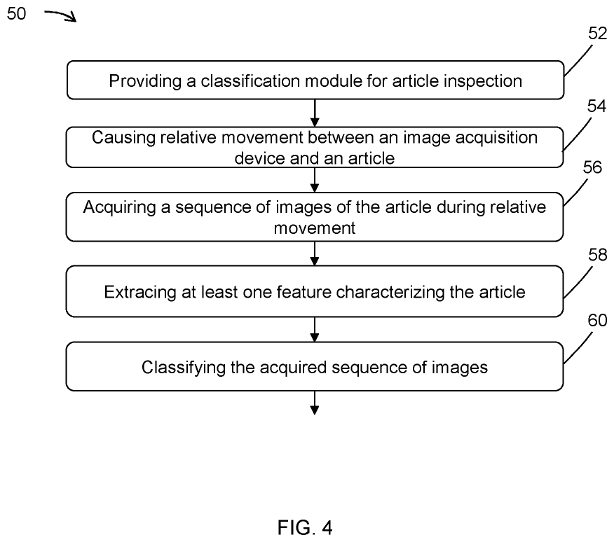

Referring now to FIGS. 2 and 3, therein illustrated are schematic illustration of an image acquisition device 8 and manufactured articles 10 during deployment of methods and systems described herein for inspection of manufactured articles. The example illustrated in FIG. 2 has an image acquisition device 8 in the form of a radiographic source and corresponding detector 12. A surface profile acquisition device 14 can also be provided.

A motion device 16 creates relative movement between the manufactured articles 10 and the image acquisition device. In the course of the present description, the term “relative movement” is used to refer to at least one of the elements moving linearly, along a curved path, rotationally, or a predefined path of an arbitrary path, with respect to the other. In other words, the motion device 16 displaces at least one of the manufactured article 10 and the image acquisition device 12, in order to generate relative movement therebetween. In the embodiment shown in FIG. 3, where the motion device 16 displaces the manufactured article 10, the motion device 16 can be a linear stage, a conveyor belt or other similar devices, displacing linearly the manufactured article 10 while the image acquisition device 8 is stationary. As described elsewhere herein, the motion device 16 can also cause the manufactured article 10 to be displaced in a non-linear movement, such as over a circular, curved, or even arbitrarily shaped path.

In another alternative embodiment, the manufactured article 10 is kept stationary and the image acquisition device 8 is displaced, such as, and without being limitative, by an articulated arm, a displaceable platform, or the like. Alternatively, both the manufactured article 10 and the image acquisition device 8 can be displaced during the inspection process.

As mentioned above, in an embodiment, the surface profile acquisition device 14 can include any device capable of performing a precise profile surface scan of the article 10 as relative movement occurs between the article 10 and the surface profile acquisition device 14 and generate surface profile data therefrom. In an embodiment, the surface profile acquisition device 14 performs a profile surface scan with a precision in a range of between about 1 micron and 50 microns. For example and without being limitative, in an embodiment, the surface profile acquisition device 14 can include one or more two-dimensional (2D) laser scanner triangulation devices positioned and configured to perform a profile surface scan of the article 12 as it is being conveyed on the motion device 10 and to generate the surface profile data for the article 12. As mentioned above, in an embodiment, the system can be free of surface profile acquisition device 14.

Where the image acquisition device 8 is a radiographic image acquisition device, it includes one or more radiographic source(s) and corresponding detector(s) 12 positioned on opposite sides of the article 10 as relative movement occurs between the article 10 and the radiographic image acquisition device 8, in order to capture a continuous sequence of a plurality of radiographic images at a known interval of the article 10. In an embodiment, the radiographic source(s) is a cone beam X-ray source(s) generating X-rays towards the article 10 and the detector(s) 14 is a 2D X-rays detector(s). In an alternative embodiment, the radiographic source(s) can be gamma-ray source(s) generating gamma-rays towards the article 10 and the detector(s) 14 can be 2D gamma-rays detector(s). In an embodiment, 1D detectors positioned such as to cover different viewing angles can also be used. One skilled in the art will understand that, in alternative embodiments, any other image acquisition device allowing subsurface scanning and imaging of the article 10 can also be used.

One skilled in the art will understand that the properties of the image acquisition device 8 can vary according to the type of article 62 to be inspected. For example, and without being limitative, the number, position and orientation of the image acquisition device 8, as well as the angular coverage, object spacing, acquisition rate and/or resolution can be varied according to the specific inspection requirements of each embodiment.

The capturing by the image acquisition device 8 produces a sequence of acquired images 18. FIG. 3 illustrates the different acquired images of the sequence 18 from the relative movement of the article 10.

Continuing with FIG. 1, the image acquisition device 8 outputs one sequence of acquired images 18 for a given manufactured article from the acquisition of the image as relative movement occurs between the article and the image acquisition device 8. Where a plurality of manufactured articles are to be inspected (ex: n number of articles), the image acquisition device 8 outputs a sequence of acquired images for each of the manufactured articles (ex: sequence 1 through sequence n).

For a given manufactured article, the sequence of acquired images for that article is inputted to a computer-implemented classification module 24. The computer-implemented classification module 24 is configured to apply a classification algorithm to classify the sequence of acquired images. It will be understood that the classification is applied by treating the received sequence of acquired images as a single sample for classification. That is, the sequence of acquired images is treated together as a collection of data and any classification determined by the classification module 24 is relevant for the sequence of acquire images as a whole (as opposed to being applicable to any one of the images of the sequence individually). However, it will also be understood that sub-processes applied by the classification module 24 to classify the sequence of acquired images may be applied to individual acquired images within the overall classification algorithm.

Classification can refer herein to various forms of characterizing the sample sequence of acquired images. Classification can refer to identification of an object of interest within the sequence of acquired images. Classification can also include identification of a location of the object of interest (ex: by framing the object of interest within a bounding box). Classification can also include characterizing the object of interest, such as defining a type of the object of interest.

As part of the classification step, the classification module 24 extracts from the received sample (i.e. the received sequence of images acquired for one given manufactured article) at least one feature characterizing the manufactured article. A plurality of features may be extracted from the sequence of acquired images.

A given feature may be extracted from any individual one image within the sequence of acquired images. This feature can be extracted according to known feature extraction techniques for a single two-dimensional digital image. Furthermore, a same feature can be present in two or more images of the acquired sequence of images. For example, the feature is extracted by applying a specific extraction technique (ex: a particular image filter) to a first of the sequence of acquired images and the same feature is extracted again by applying the same extraction technique to a second of the sequence of acquired images. The same feature can be found in consecutively acquired images within the sequence of acquired images. The presence of a same feature within a plurality of individual images within the sequence of acquired images can be another metric (ex: another extracted feature) used for classifying the received sample.

A given feature may be extracted from a combination of two or more images of the sequence of acquired images. Accordingly, the feature can be considered as being defined by image data contained in two or more images of the acquired sequence of images. For example, the given feature can be extracted by considering image data from two acquired images within a single feature extraction step. Alternatively, the feature extraction can have two or more sub-steps (which may be different from one another) and a first of the sub-steps is applied to a first of the acquired images to extract a first sub-feature and one or more subsequent sub-steps are applied to other acquired images to extract one or more other sub-features to be combined with the first sub-feature to form the extracted feature. The featured extracted from a combination of two or more images can be from two or more consecutively acquired images within the sequence of acquired images.

According to one example embodiment, the extracting one or more features (same features or different features) can be carried out by applying feature tracking across two or more images of the sequence of acquired images. To extract a given feature or a set of features, a first feature can be extracted or identified from a first acquired image of the received sequence of acquired images. The location of the feature within the given first acquired image can also be determined. A prediction of a location of a second feature within a subsequent acquired image of the sequence of acquired images is then determined based on the location and/or type of the first extracted feature. The prediction of the location can be determined by applying feature tracking for a sequence of images. The tracking can be based on the known characteristics of the relative movement of the article 10 and the image acquisition device 8 during the image acquisition step. The known characteristics can include the speed of the movement of the article and the frequency at which images are acquired. The second feature located within the subsequent acquired image can then be extracted based in part on the prediction of the location.

The extracting of one or more sub-features (to be used for forming a single feature) can also be carried out by applying feature tracking across two or more images of the sequence of acquired images. A first sub-feature can be extracted or identified from a first acquired image of the received sequence of acquired images. The location of the sub-feature within the given first acquired image can also be determined. A prediction of a location of a second sub-feature related to the first sub-feature within a subsequent acquired image of the sequence of acquired images is then determined based on the location and/or type of the first extracted sub-feature. The prediction of the location can be determined by applying feature tracking for a sequence of images. The tracking can also be based on the known characteristics of the relative movement of the article 10 and the image acquisition device 8 during the image acquisition step. The known characteristics can include the speed of the movement of the article and the frequency at which images are acquired. The second sub-feature located within the subsequent acquired image can then be extracted based in part on the prediction of the location.

According to various example embodiments, the classification of the sequence of acquired images can be carried out by defining a positional attribute for each of a plurality of pixels and/or regions of interest of a plurality of images of the sequence of acquired images. It will be appreciated that due to the movement of the manufactured article relative to the image acquisition device during the acquisition of the sequence of image steps, a same given real-life spatial location of the manufactured article (ex: a corner of a rectangular prism-shaped article) will appear at different pixel locations within separate images of the sequence of acquired images. The defining of a positional attribute for pixels or regions of interest of the images creates a logical association between the pixels or regions of interest with the real-life spatial location of the manufactured article so that that real-life spatial location can be tracked across the sequence of acquired images. Accordingly, a first given pixel in a first image of the sequence of acquired images and a second pixel in a second image of the sequence of acquired images can have the same defined positional attribute, but will have different pixel locations within their respective acquired images. The same defined positional attribute corresponds to the same spatial location within the manufactured article.

In some example embodiments, the positional attribute for each of the plurality of pixels and/or regions of interest can be defined in a two-dimensional plane (ex: in X and Y directions).

In other example embodiments, the positional attribute for each of the plurality of the plurality of pixels and/or regions of interest can be defined in three dimensions (ex: in a Z direction in addition to X and Y directions). For example, images acquired by radiographic image acquisition devices will include information regarding elements (ex: defects) located inside (i.e. underneath the surface) of a manufactured article. While a single acquired image will be two dimensional, the acquisition of the sequence of plurality of images during relative movement between the manufactured article and the image acquisition device allows for extracting three-dimensional information from the sequence of images (ex: using parallax), thereby also defining positional attributes of pixels and/or regions of interest in three dimensions.

It will be appreciated that defining the positional attribute of regions of interest with the real-life spatial location of the manufactured article further allows for relating the regions of interest to known geometrical information of the ideal (non-defective) manufacture article. It will be further appreciated that being able to define the spatial location of a region of interest within the manufactured article in relation to geometrical boundaries of the manufactured article provides further information regarding whether the region of interest represents a manufacturing defect. For example, it can be determined whether the region of interest representing a potential defect is located in a spatial location at a particular critical region of the manufactured article. Accordingly, the spatial location in relation to the geometry of the manufactured article allows for increased accuracy and/or efficiency in defect detection.

According to one example embodiment, the acquired sequence of images is in the form of a sequence of differential images. An ideal sequence of images for a non-defective instance of the manufactured article can be initially provided. This sequence of images can be a sequence of simulated images for the non-defective manufactured article. This sequence of simulated images represents how the sequence of images captured of an ideal non-defective instance of the manufactured article would appear. This sequence of simulated images can correspond to how the sequence would be captured for the given speed of relative movement of the article and the frequency of image acquisition when testing is carried out.

The ideal sequence of images can also be generated by capturing a non-defective instance of the manufactured article. For example, a given of manufactured article can be initially tested using a more thorough or rigorous testing method to ensure that it is free of defect. The ideal sequence of images is then generated by capturing the given instance of the manufactured article at the same speed of relative movement and image acquisition frequency as will be applied in subsequent testing.

During testing, the sequence of differential images for a manufactured article is generated by acquiring the sequence of image for the given article and subtracting the acquired sequence of images from the ideal sequence of images for the manufactured article. It will be appreciated that the sequence of differential images can be useful in highlighting difference between the ideal sequence of images and the actually captured sequence of images. Similarities between the ideal sequence and the captured sequence have lower captured values while differences have higher values, thereby emphasizing these differences. The classification is then applied to the differential images.

Continuing with FIG. 1, the classification module 24 outputs a classification output 32 that indicates a class of the received sequence of acquired images. The classification is determined based in part on the at least one feature extracted from the sequence of images. The classification output 32 characterizes the received sequence of acquired images as sharing characteristics with other sequences of acquired images that are classified by the classification module 24 within the same class, and those having characteristics that are different from other sequences of acquired images are classified by the classification module 24 into another class.

The classification module 24 can optionally output a visual output 40 that is a visualization of the sequence of acquired images. The visual output 40 can allow a human user to visualize the sequence of acquired images and/or can be used for further determining whether a defect is present in the manufactured article captured in the sequence of acquired images. The generating of the visual output 40 can be carried out using the inspection method described in PCT publication no. WO2018/014138, which is hereby incorporated by reference. The visual output 40 can include a 3D model of the manufactured article captured in the sequence of acquired images, which may be used for defect detection and/or metrology assessment. Features extracted by the classification module 24 may further be represented as visual indicators (ex: bounding boxes or the like) overlaid on the visual output 40 to provide additional visual information for a user.

According to one example embodiment, the classification output 32 generated by the classification module 24 includes an indicator of a presence of a manufacturing defect in the article. For example, the determination of the presence of a manufacturing defect in the article can be carried out by comparing the extracted at least one feature against predefined sets of features that are representative of a manufacturing defect.

According to one example embodiment, the indicator of a presence of a manufacturing defect in the article can further include a type of the manufacturing defect. For example, the determination of the type of the manufacturing defect in the article can be carried out by comparing the extracted least one feature against a plurality of predefined sets of features that are each associated with a different type of manufacturing defect.

The classification output 32 generated by the classification module 24 can be used as a decision step within the manufacturing process. For example, manufactured articles having sequences of acquired images that are classified as having a presence of a manufacturing defect can be withdrawn from further manufacturing. These articles can also be selected to undergo further inspection (ex: a human inspection, or a more intensive inspection, such as 360-degree CT-scan).

Continuing with FIG. 1, according to one example embodiment, the classification module 24 is trained by applying a machine learning algorithm to a training captured dataset that includes samples previously presented by the image acquisition device 8 or similar image acquisition equipment (i.e. equipment capturing samples that have a sufficient relevancy to samples captured by the image acquisition equipment). The data samples of the training captured dataset include samples captured of a plurality of manufactured articles having the same specifications (ex: same model and/or same type) as the manufactured articles to be inspected using the classification module 24.

Each sample of the training captured dataset used for training the classification module 24 is one sequence of acquired images captured of one manufactured article. In other words, in the same way that each received sequence of acquired images is treated as a single sample for classification when the classification module 24 is in operation, each sequence of acquired images of the training captured dataset is treated as a single sample for training the classification module 24 prior to operation. The sequences of acquired images of the training captured dataset can further be captured by operating the image acquisition device 8 with the same acquisition parameters as those to be later used for inspection of manufactured articles (subsequent to completing training of the classification module). Such acquisition parameters can include the same relative movement of the image acquisition device 8 with respect to manufactured articles.

In one example embodiment, the samples of the training captured dataset can include a plurality of sequences of simulated images, with each sequence representing one sample of the training captured dataset. In the NDT field, software techniques have been developed to simulate the operation of X-ray image techniques, such as radiography, radioscopy and tomography. More particularly, based on a CAD model of a given manufactured article, the software simulator is operable to generate simulated images as would be captured by an X-ray device. The simulated images are generated based on ray-tracing and X-ray attenuation laws. The sequence of simulated images can be generated in the same manner. Furthermore, by modeling defects in the CAD model of the manufactured articles, sequences of simulated images can be generated for the modeled manufactured articles containing defects. These sequences of simulated images may be used as the training dataset for training the classification module by machine learning. The term “training captured dataset” as used herein can refer interchangeably to sequences of images actually captured of manufactured articles and/or to sequences of images simulated from CAD models of manufactured articles.

According to one example embodiment, each of the samples of the training captured dataset can be annotated prior to their use for training the classification module 24. Accordingly, the classification module 24 is trained by supervised learning. Each sample, corresponding to a respective manufactured article, can be annotated based on an evaluation of data captured for that manufactured article using another acquisition technique (such as traditional 2-D image or more intensive capture methods such as CT scan). Each sample can also be annotated based on a human inspection of the data captured for that manufactured article.

Within the example embodiment for supervised learning of the classification module 24, prior to deployment, each sample of the training dataset can be annotated to indicate whether that sample is indicative of a presence of a manufacturing defect or not indicative of a presence of a manufacturing defect. Accordingly, the classification module 24 can be trained to classify, when deployed, each of the sequences of acquired images that it receives according to whether that sequence has or does not have an indication of the presence of a manufacturing defect.

According to another example embodiment, and also within the context for supervised learning of the classification module 24, prior to deployment, each sample of the training dataset can be annotated to indicate the type of manufacturing defect. Accordingly, the classification module 24 can be trained to classify, when deployed, each of the sequences of acquired images according to whether that sequence does not have a presence of a manufacturing defect or by the type of the manufacturing defect present in the sequence of acquired images.

The training of the classification module 24 allows for the learning of features found in the training captured dataset that are representative of particular classes of the sequences of acquired images. Referring back to FIG. 1, a trained feature set 48 is generated from the training of the classification module 24 from machine learning, and the feature set 48 is used, during deployment of the classification module 24, for classifying subsequently received sequences of acquired images 32.

According to yet another example embodiment, the classification module 24 can classify sequences of acquired images of manufactured articles in an unsupervised learning context. As is known in the art, in the unsupervised learning context, the classification module 24 learns feature sets present in the sequences of acquired images that are representative of different classes without the samples previously having been annotated. It will be appreciated that the classification of the sequences of acquired images by unsupervised learning context allows for the grouping, in an automated manner, of sequences of acquired images that share common image features. This can be useful in a production context, for example, to identify manufactured articles that have common traits (ex: a specific manufacturing feature, which may be a defect). The appearance of the common traits can be indicative of a root cause within the manufacturing process that requires further evaluation. It will be appreciated that even through the unsupervised learning does not provide a classification of the presence of a defect or a type of the defect, the classification from unsupervised learning provides a level of inspection of manufactured articles that is useful for improving the manufacturing process.

According to various example embodiments, the computer-implemented classification module 24 has a convolutional neural network architecture. This architecture can be used for both the supervised learning context and the unsupervised learning context. More particularly, the at least one feature is extracted by the computer-implemented classification module from the received sequence of acquired images (representing one sample) by applying the convolutional neural network. The convolutional neural network can implement an object detection algorithm to detect features of the acquired images, such as one or more sub-regions of individual acquired images of the sequences that are features characterizing the manufactured article. Additionally, or alternatively, the convolutional neural network can implement semantic segmentation algorithms to detect features of the acquired images. This can also be applied to individual acquired images of the sequences.

According to various example embodiments, the classification module 24 can extract features across a plurality of images of each sequence of acquired images. This can involve defining a feature across a plurality of images (ex: sub-features found in different images are combined to form a single feature). Alternatively, multiple features can be individually extracted from a plurality of images and identified to be related features (ex: the same feature found in multiple images). As described, feature tracking can be implemented (ex: predicting the location of subsequent features from one image to another). Accordingly, the convolutional neural network can have an architecture that is configured to extract and/or track features across different images of the sequence of acquired images.

For example, the convolutional neural network of the classification module 24 can have an architecture in which at least one of its convolution layers has at least one filter and/or parameter that is applied to two or more images of the sequence of acquired images. In other words, the filter and/or parameter receives as its input the image data from the two or more images of the sequence at the same time and the output value of the filter is calculated based on the data from the two or more images.

As described elsewhere herein, the classification can include defining a positional attribute for each of a plurality of pixels and/or regions of interest of the plurality of images of the sequence of acquired images. The defining of the positional attributes allows associating pixels or regions found at different pixel locations across multiple images of the sequence but that the pixels or regions corresponds to the same real-life spatial location of the manufactured article. Accordingly, where a feature is defined across a plurality of images or multiple features are individually extracted from a plurality of images, this feature extraction can be based on pixel data in the multiple images that share common positional attributes. For example, where a convolution layer has a filter applied to two or more images of the sequence of acquired images, the filter is applied to pixels of the two or more images having common positional attributes but that can have different pixel locations within the two or more images. It will be appreciated that defining the positional attributes allows linking data across multiple images of the sequence of acquired images based on their real-life spatial location while taking into account differences in pixel locations within the captured images due to the relative movement of the manufactured article with respect to the image acquisition device 8.

It will be understood that various example embodiments described herein is operable to extract features found in the image data contained in the sequence of acquired images without generating a 3D model of the manufactured article. As described, features can be extracted from individual images of the sequence of images. Features can also be extracted from image data contained in multiple images. However, even in this case, the image data used can be less than the data required to generate a 3D model of the manufactured article.

Referring now to FIG. 3, therein illustrated is a flowchart showing the operational steps of a method 50 for performing inspection of one or more manufactured articles. The method 50 can be carried out on the system 1 for inspection of the manufactured articles as described herein according to various example embodiments.

At step 52, a classification module suitable for article inspection is provided. For example, this can be the classification module 24 as described herein according to various example embodiments. The providing step

At step 54, movement of an image acquisition device relative to a given manufactured article under test is caused. As described elsewhere herein, the manufactured article can be displaced while the image acquisition device is stationary. Alternatively, the image acquisition device is displaced while the manufactured article is stationary. In a further alternative embodiment, both the image acquisition device and the manufactured article can be displaced to cause the relative movement.

At step 56, a sequence of images of the manufactured article is acquired while the relative movement between the article and the image acquisition device is occurring.

At step 58, at least one feature characterizing the manufactured article is extracted from the sequence of images acquired for that article. The at least one feature is extracted by the provided classification module.

At step 60, the acquired sequence of images is classified based in part on the at least one extracted feature.

Based on the classification of the acquired sequence of images, an indicator of presence of possible defect can be outputted. Additional inspection steps can be carried out where the indicator of presence of possible defect is outputted. The additional inspection steps can include a more rigorous inspection, or removing the manufactured article from production.

The acquisition of a sequence of images can contain more information related to characteristics of a given manufactured article when compared to a single (ex: 2-D) image. As described herein, each image of the sequence can provide a unique viewing angle of the manufactured article such that each image can contain information not available in another image. Alternatively, or additionally, aggregating information across two or more images can produce additional defect-related information that would otherwise not be available where single is image is acquired.

As described elsewhere herein, the capturing of a sequence of images for a given manufactured article can also allow for defining positional attributes of regions of interest within the manufactured article. The spatial location can be further related to known geometric characteristics (ex: geometrical boundaries) of the manufactured article. This information can further be useful when carrying out classification of the acquired sequence of images.

Systems and methods described herein according to various example embodiments can be deployed within a production chain setting to perform an automated task of inspection of manufactured articles. The systems and methods based on classification of sequences of images captured for each manufactured article can be deployed on a stand-alone basis, whereby the classification output is used as a primary or only metric for determining whether a manufactured article contains a defect. Accordingly, manufactured articles that are classified by the classification module 24 as having a defect is withdrawn from further inspection. The systems and methods based on classification of sequences of images can also be applied in combination with other techniques such as defect detection based on 3D modeling or metrology. For example, the classification can be used to validate defects detected using another technique, or vice versa. The classification, especially in an unsupervised learning context, can also be used to identify trends or indicators within the manufacturing process representative of an issue within the process. For example, the classification can be used to identify when and/or where further inspection should be conducted.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

### EXPERIMENTAL RESULTS

A public database called GDXray is used for each of the 3 experiments described herein. This database contains several samples of radiographic images including images of welding with porosity defects. The database already contains segmented image samples, which is a good basis for training a small network. Additional training images were generated from the database by segmenting images from the database into smaller images, performing rotations, translations, negatives and generating noisy images. A total of approximately 23000 training images are generated from 720 original distinct images. 90% of the images were used as training data, and 10% as test data. In addition, a cross validation of training data was performed by separating 75% for training and 25% for validation.

### Experiment 1

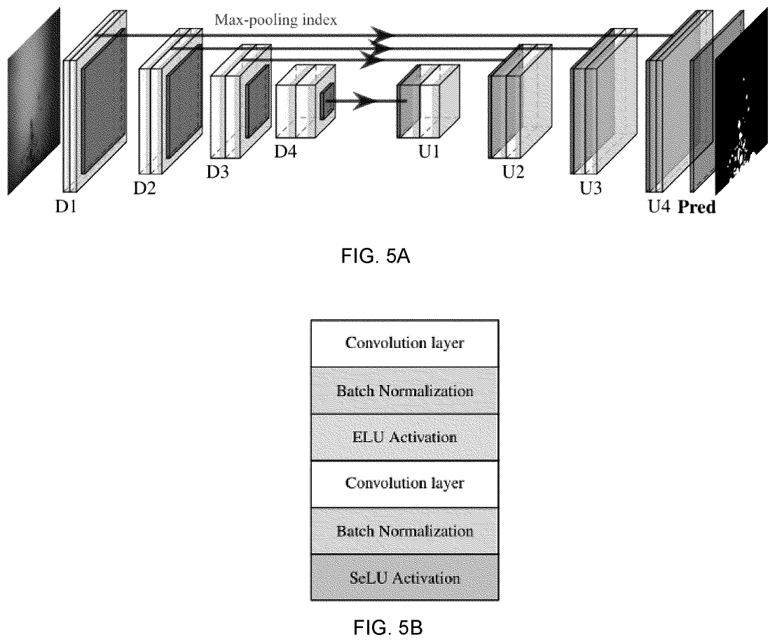

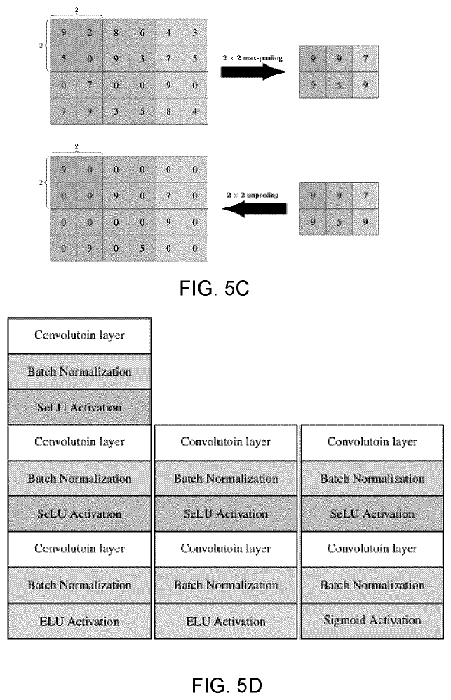

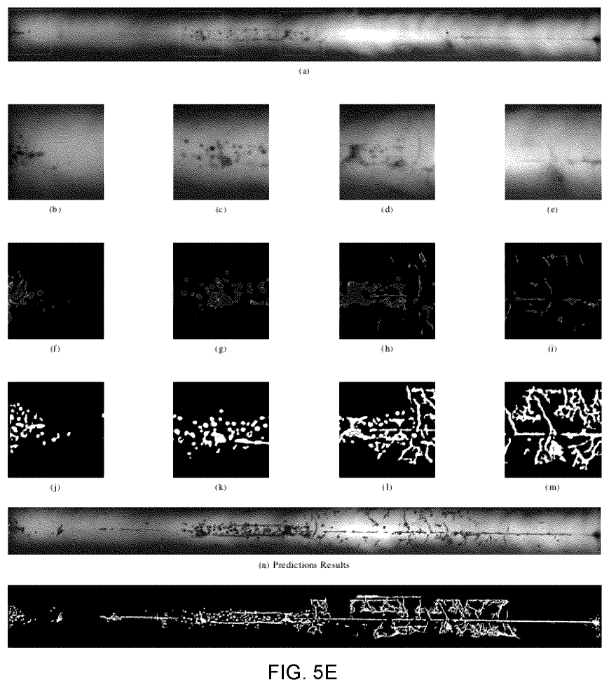

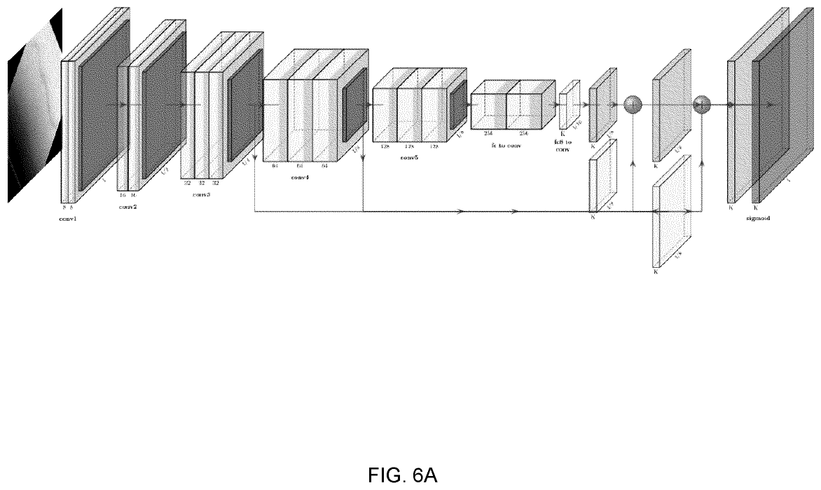

In FIG. 5A shows two sections of the encoder-decoder architecture used in a first experiment, the encoder being on the left while the decoder is on the right. The encoder consists of 4 convolution blocks (D1-D4) and 4 pooling layers. Convolution blocks perform the following operations: convolution, batch normalization and application of an activation function. FIG. 5B shows the convolution blocks, being composed of 6 layers with layers 3 and 6 being activation layers whose activation functions are exponential linear unit (ELU) and scaled exponential linear unit (SeLU) respectively. The choice of these activation functions is based on the following properties of each function; 1) They keep the simplicity and speed of calculation of the rectified linear unit (ReLU) activation function, which is the reference activation function in most state of the art deep learning models, when the values are greater than zero. 2) They treat values near or below zero in two different ways; as indicated in their name, exponentially and exponentially scaled. As a result, the network is in continuous learning mode, because unlike ReLU, the ELU and SeLU functions are unlikely to disable entire layers of the network by propagating zero values in the network. This phenomenon is known as the dying ReLU. The last layer of each encoder block is a pooling layer that consists of generating a feature map at each resolution level. As shown in FIG. 5C, this operation reduces the size of the image by a factor of two each time it is applied. This operation allows to keep the pixels representing the elements that best represent the image. To do this, keep the largest pixel value in a kernel of any size and the position of this pixel which allows having a spatial representation of the pixels of interest. As a result, the network learns to encode not only the essential information of the image, but also its position in space. This approach makes it easier to reconstruct the information performed by the decoder.

The decoder consists of 4 convolution blocks (U1-U4) and 4 unpooling layers. Convolution blocks perform the same operations as D1-D4, but are organised a bit differently as shown in FIG. 5D. The blocks U1 and U2 have one more block of convolution, batch normalization and activation. The blocks U3 and U4 follows the same convention in terms of operations as Dx except that the last layer of U4 is the prediction layer, which means that the activation function will not be ELU or SeLU, but the sigmoid function. Comparison of the prediction with ground truth image is carried out using the Dice loss function.

FIG. 5E show the prediction results of the encoder-decoder model on a radiographic image. In order to cover the entire surface of the test image, a mask is generated in which the area where the weld is located is delimited manually. “Sliding window” is used to allow making pixel-by-pixel predictions in the selected area. The results of this manipulation can be seen in FIG. 5E.n. the output values will be between 0 (no defect) and 1 (defect) to interpret these values as a probability value that a given pixel represents an area containing a defect or not. In FIG. 5E, image a represents the manually selected area for predicting the location of defects. The images b to e represent a close-up view of the yellow outlined areas in the original image a. The images f to i represent the predictions made the network. The representation chosen to show the results is a heat map in which the dark blue represents the pixels where the network does not predict any defect and in red the pixels where the network predicts a strong representation of a defect. The images j to m represent the ground truth images associated with the framed areas in the original image a.

These experimental results show that the network architecture of experiment 1 to performing semantic segmentation can be applied to detect porosity defects in radiographic images representing a welded area. The reliability of the predictions is measured using a metric called F1. Precision is a measure to calculate the ability of the system to predict pixels belonging to both classes in the right regions and to calculate the sensitivity of the network when predicting true positives. In this experiment 1, a F1 score of 80% was obtained.

### Experiment 2

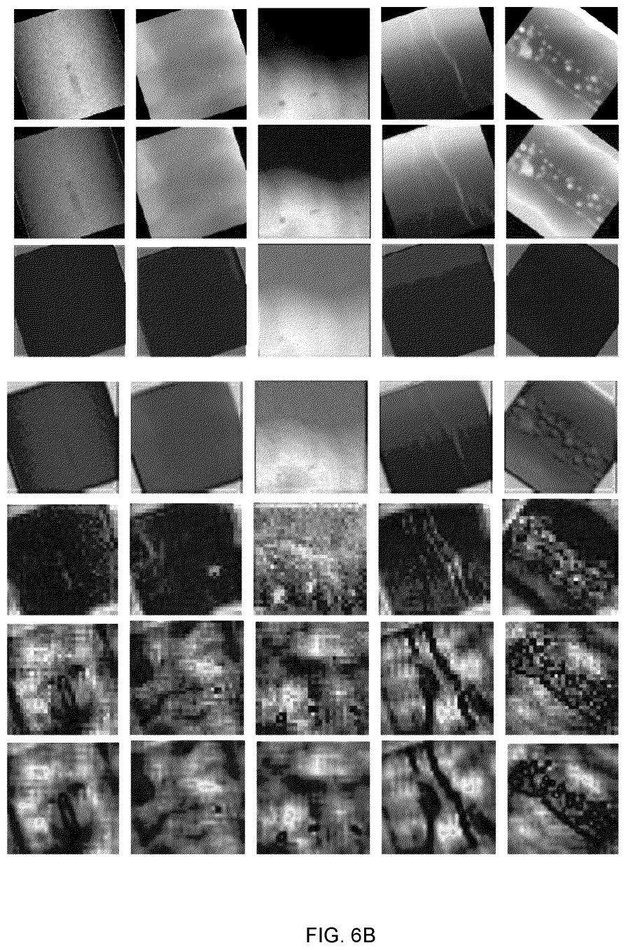

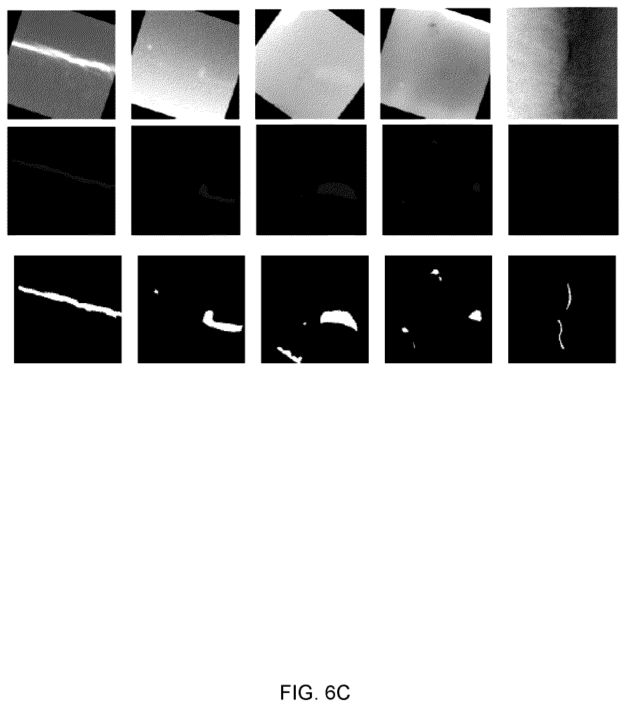

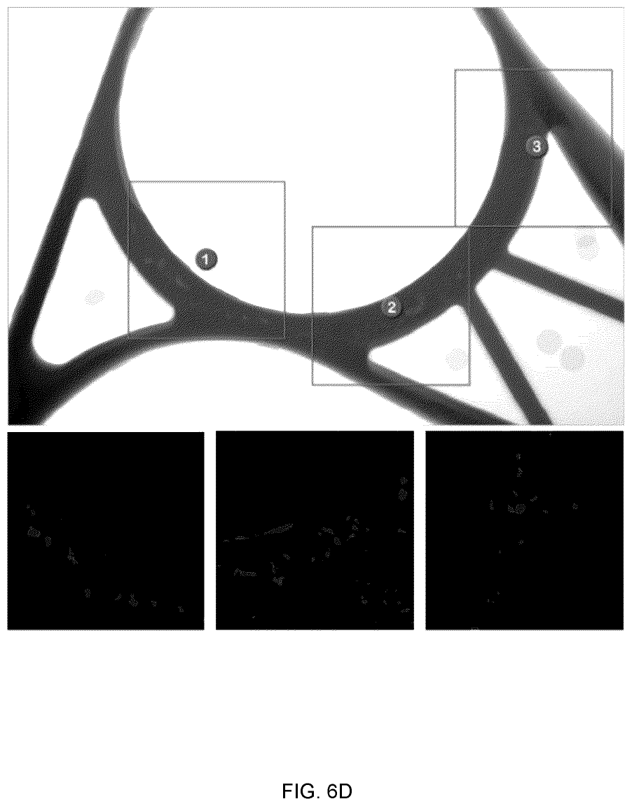

The database GDXray is also used for experiment 2. An architecture having an end to end full Convolution Network (FCN) is constructed to perform semantic segmentation of defect in the images. A schematic diagram of the FCN architecture is illustrated in FIG. 6A. The FCN according to experiment achieved a F1 score of 70%.

FIG. 6B shows an example of an overview of the feature map that activates the network on different layers. On the first row, 5 input images from 5 different welds are placed. Each following row contains a visual representation of the areas (in red and yellow) that the network considers relevant for classification purposes. It can be seen that in the first two layers, the network focuses on the areas of the image where the contrasts are generally distinct, this represents the basic properties of the problem. In layers 3 and 4 the network seems to want to detect shapes and the last two layers seem to refine the detection of objects of interest, in this case, porosity defects. It should be understood that this interpretation does not reflect in any way the method used by this type of network to learn. FIG. 6B illustrates some examples of the solution found by the network of experiment to achieve the goal, which is the semantic segmentation of porosity defects found in images of welded parts.

FIG. 6C shows the results obtained when applying the network to the test data. The first row represents the input images, the second row represents the predictions of the network of experiment 2 and the last row represents the ground truth images. The prediction images are heatmaps of the probability that a pixel represents a defect. Red pixels represent a high probability of a defect while blue corresponds to a low probability.

FIG. 6D shows predictions on non-weld images.

The experiment 2 is shown to be useful in detecting porosities in welding.

### Experiment 3

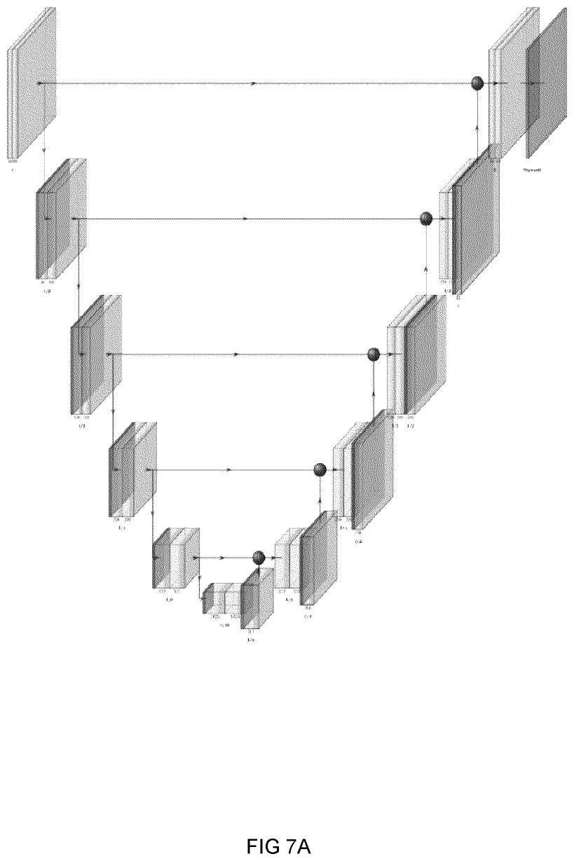

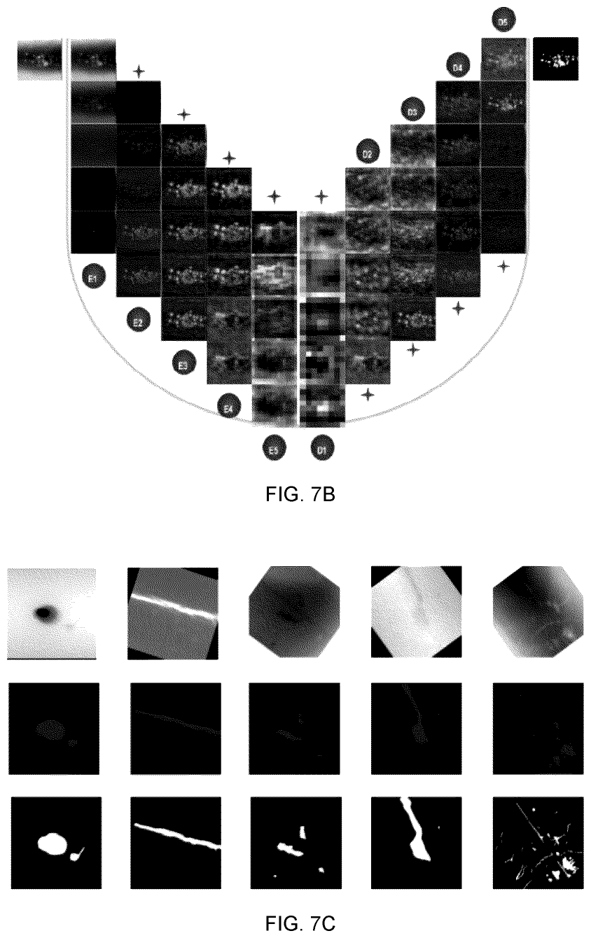

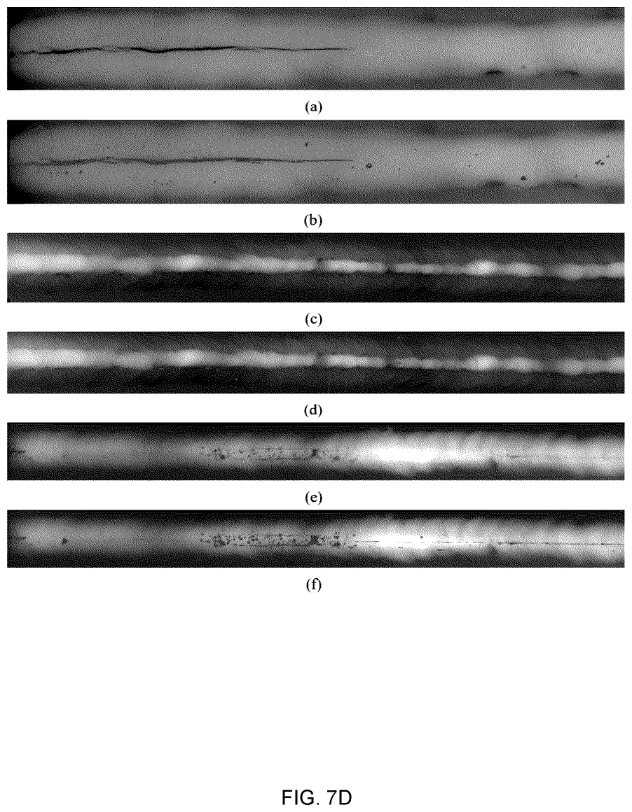

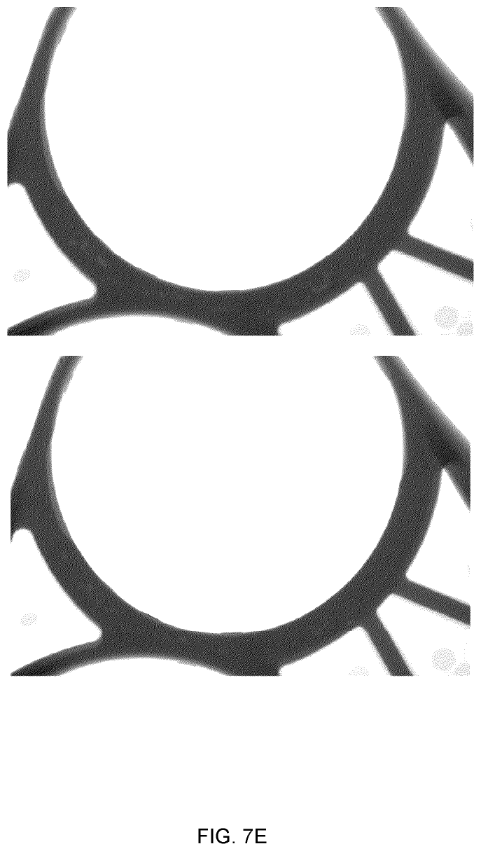

In Experiment 3, a U-Net model is developed. As shown in FIG. 7A, the U-Net model is shaped like the letter U, thus its name. The network is divided into three sections, the contraction (also called encoder), the bottleneck and the expansion (also called decoder). On the left side, the encoder consists of a traditional series of convolutional and max-pooling layers.

The number of filters in each block is doubled so that the network can learn more complex structures more effectively. In the middle, the bottleneck acts only as a mediator between the encoder and decoder layers. What makes the U-Net architecture different from other architectures is the decoder. The decoder layers perform symmetric expansion in order to reconstruct an image based on the features learned previously. This expansion section is composed of a series of convolutional and upsampling layers. What really makes the difference here, is that each layer gets as input the reconstructed image from the previous layer with the spatial information saved from the corresponding encoder layer. The spatial information is then concatenated with the reconstructed image to form a new image.

FIG. 7B shows the effect of the concatenation by identifying the concatenated images with a star. FIG. 7B shows an illustration of the input and output data that is computed by each layer. Each image is the result of the application of the operation associated with the layer. As mentioned previously, the contraction section is composed of convolutional and max-pooling layers. In the network of Experiment 3, a batch normalization layer is added at the end of each block because SELU and ELU are used as activation function. From top to bottom, each block from the encoder section are similar except for the first block. E1 is organized in the following manner: 1) Intensity normalization, 2) Convolution with a 3×3 kernel and an ELU activation, 3) Batch normalization, 4) Convolution with a 3×3 kernel and a SELU activation, 5) Batch normalization. Each subsequent block E2-E5 are organized in the following manner; 1) Max-pooling with a 2×2 kernel, 2) Convolution with a 3×3 kernel and an ELU activation, 3) Batch normalization, 4) Convolution with a 3×3 kernel and a SELU activation, 5) Batch normalization. The max-pooling operation keeps the highest value in the kernel when sliding it in the image which produces a new image. As a result, the resulting image is smaller than the input by a factor of two. In FIG. 7B, the images can be identified with a star. From bottom to top, each block from the decoder section are similar except for the last block. D5 is organized in the following manner; 1) Transpose convolution (upsampling) with a 2×2 kernel, a stride of 2 in each direction and concatenation, 2) Convolution with a 3×3 kernel and an ELU activation, 3) Batch normalization, 4) Convolution with a 3×3 kernel and a SELU activation, 5) Batch normalization, 6) Image classification with a Sigmoid activation. Each previous block D1-D4 are organized in the following manner; 1) Transpose convolution (upsampling) with a 2×2 kernel, a stride of 2 in each direction and concatenation, 2) Convolution with a 3×3 kernel and an ELU activation, 3) Batch normalization, 4) Convolution with a 3×3 kernel and a SELU activation, 5) Batch normalization. The upsampling with a stride of 2 in each direction will generate an image where the values from the max-pooling are separated by a pixel that has a value of 0. As a result, the resulting image is bigger than the input by a factor of two. Then the corresponding encoder layer image is added to the one that has been generated. Such images can be identified with a star in FIG. 7B. Looking at what's going on inside the network gives a new understanding of the data that composed the processed image, leading to insights about the feature maps, the data distribution, more importantly, it is a tool that can be used to help to design a network model.

Results are presented in three categories. The individual generated mask in a portion of the real image so a closeup view can be had. The production view shows the original image with an overlay of the defects detected by the network of experiment. Finally, some results obtained on an image that does not represent a weld are shown. That image, however, does contain indicators that can be classified as porosity. FIG. 7C (Network predictions without sliding window. First row: input image, Second row: Network predictions; Third row: Ground-truth data), FIG. 7D (Network predictions with sliding window. (a), (c), and (e) are the original images from GDXray; (b), (d) and (f) are the network predictions), FIG. 7E show that the network model is able to detect different kinds of defects present in an image. In FIG. 7C, the network of experiment is shown to perform well on low and high contrast images. Thin defects are seen to be harder to detect. Overall, the network of experiment 3 achieved a F1 score was 80%, meaning the network model was able to detect 80% of the defects present in an image. To obtain the images presented in FIG. 7D, a technique called sliding window is, it consists of predicting a portion of the image that is as big as the input size of the network (256×256) and sliding it across the entire image. Since the network was trained with weld images to detect defects, the resulting images are only ones containing defects, therefore the model network sees the entire image. Knowing that, it was hypothesized that the network can perform for images that presents similar patterns. To validate this hypothesis, the same network was used for an image that does not represent a weld and it can be seen in FIG. 7E that the network is still able to detect and classify defects in that image. This could mean that the network model of Experiment 3 trained on weld images has the potential to be fine tuned for any kind of radiographic images of objects with defects.

### REFERENCES

V. Z. U. M. G.-L. I. Z. I. L. H. C. M. “Mery, D.; Riffo, “Gdxray: The database of x-ray images for nondestructive Testing.,” 2015. 34.4:1-12.

1. A method for performing inspection of a manufactured article, the method comprising:
acquiring a sequence of images of the article using an image acquisition device, the acquisition of the sequence of images being performed as relative movement occurs between the article and the image acquisition device;
extracting, from the acquired sequence of images, at least one feature characterizing the manufactured article; and
classifying the acquired sequence of images based in part on the at least one extracted feature.

2. The method of claim 1, wherein the classifying comprises determining an indication of a presence of a manufacturing defect in the article, determining the indication of the presence of the manufacturing defect in the article comprises identifying a type of the manufacturing defect.

3. (canceled)

4. The method of claim 1, wherein the acquired sequence of images is in the form of a sequence of differential images corresponding to differences between the acquired sequence of images and a sequence of ideal images.

5. The method of claim 1, wherein the extracting the at least one feature and classifying the acquired sequence of images is performed by a computer-implemented classification module trained based on one of a training captured dataset of a plurality of previously acquired sequences of images and a training captured dataset of a plurality of simulated sequences of images, each sequence representing one sample of the training captured dataset.

6-7. (canceled)

8. The method of claim 5, wherein the computer-implemented classification module is a convolutional neural network with at least one convolution layer of the convolutional neural network having at least one filter receiving as its input the image data from two or more images of the acquired sequence of images;
wherein the input image data received by the at least one filter corresponds to a same spatial location within the manufactured article, the spatial location being positioned at different pixel locations within the two or more acquired images; and
wherein the at least one feature characterizing the manufactured article is extracted by applying the convolutional neural network to the sequence of acquired images.

9-10. (canceled)

11. The method of claim 1, wherein the at least one feature is present in two or more images of the acquired sequence of images and the at least one feature is generated from a combination of the same feature present in the two or more images of the acquired sequence of images, the two or more images being consecutively acquired images within the sequence of acquired images.

12-13. (canceled)

14. The method of claim 11, wherein the extracting comprises:
identifying a first feature or sub-feature in a first of the two or more images;
predicting a location of a second feature or sub-feature in a second of the two or more images based on the identified first feature or sub-feature; and
identifying the second feature or sub-feature in the second of the two more images based on the prediction.

15. The method of claim 1, further comprising defining a positional attribute for each of a plurality of pixels of a plurality of images of the sequence of acquired images, wherein a first given pixel in a first image of the sequence of acquired images and a second given pixel in a second image of the sequence of acquire images have a same positional attribute and have different pixel locations within their respective acquired images and wherein the same positional attributes correspond to a same spatial location within the manufactured article, the positional attribute being defined in three dimensions.

16-18. (canceled)

19. The method of claim 1, wherein the determination of the classification of the acquired sequence of images is made without generating a 3D model of the manufactured article from the sequence of acquired images.

20. The method of claim 1, wherein the image acquisition device is one of a radiographic image acquisition device, visible range camera, or infrared camera.

21-23. (canceled)

24. A system for performing inspection of a manufactured article, the system comprising:
an image acquisition device configured to acquire a sequence of images of the manufactured article as relative movement occurs between the article and the image acquisition device; and
a computer-implemented classification module configured to extract at least one feature characterizing the manufactured article and to classify the acquired sequence of images based in part on the at least one extracted feature.

25. The system of claim 24, wherein the classifying comprises determining an indication of a presence of a manufacturing defect in the article and wherein determining the indication of the presence of the manufacturing defect in the article comprises identifying a type of the manufacturing defect.

26. (canceled)

27. The system of claim 24, wherein the acquired sequence of images is in the form of a sequence of differential images corresponding to differences between the acquired sequence of images and a sequence of ideal images.

28. The system of claim 24, wherein the computer-implemented classification module is trained based on one of a training captured dataset of a plurality of previously acquired sequences of images and a training captured dataset of a plurality of simulated sequence of images, each sequence representing one sample of the training captured dataset.

29. (canceled)

30. The system of claim 24, wherein the computer-implemented classification module is a convolutional neural network with at least one convolution layer of the convolutional neural network having at least one filter receiving as its input the image data from two or more images of the acquired sequence of images:
wherein the input image data received by the at least one filter corresponds to a same spatial location within the manufactured article, the spatial location being positioned at different pixel locations within the two or more acquired images; and
wherein the at least one feature characterizing the manufactured article is extracted by applying the convolutional neural network to the sequence of acquired images.

31-32. (canceled)

33. The system of claim 24, wherein the at least one feature is present in two or more images of the acquired sequence of images and the at least one feature is generated from a combination of the same feature present in the two or more images of the acquired sequence of images, the two or more images being consecutively acquired images within the sequence of acquired images.

34-35. (canceled)

36. The system of claim 33, wherein the extracting comprises:
identifying a first feature or sub-feature in a first of the two or more images;
predicting a location of a second feature or sub-feature in a second of the two or more images based on the identified first feature or sub-feature; and
identifying the second feature or sub-feature in the second of the two more images based on the prediction.

37. The system of claim 24, wherein the classification module is further configured for defining a positional attribute for each of a plurality of pixels of a plurality of images of the sequence of acquired images, with a first given pixel in a first image of the sequence of acquired images and a second given pixel in a second image of the sequence of acquire images having a same positional attribute and having different pixel locations within their respective acquired images and wherein the same positional attributes correspond to a same spatial location within the manufactured article, the positional attribute being defined in three dimensions.

38-40. (canceled)

41. The system of claim 24, wherein the determination of the classification of the acquired sequence of images is made without generating a 3D model of the manufactured article from the sequence of acquired images.

42. The system of claim 24, wherein the image acquisition device is one of a radiographic image acquisition device, visible range camera, or infrared camera.

43-45. (canceled)
